(19) United States
(12) Patent Application Publication
(10) Pub. No.: US 2007/0005361 A1
(43) Pub. Date: Jan. 4, 2007

(54) Process and device for interaction with a speech recognition system for selection of elements from lists

(75) Inventors: Harald Huning, Blaustein (DE); Susanne Kronenberg, Ulm (DE); Michael Munz, Ulm (DE)

Correspondence Address: AKERMAN SENTERFITT, P.O. BOX 3188, WEST PALM BEACH, FL, 33402-3188, US

(73) Assignee: DaimlerChrysler AG

(21) Appl. No.: 11/478,929

(22) Filed: Jun. 30, 2006

(30) Foreign Application Priority Data
Jun. 30, 2005 (DE) 102005030967.4-42

(51) Int. Cl. G10L 15/04

(52) U.S. Cl. 704/251

(57) ABSTRACT

Due to the large vocabulary to be recognized, it is presently not possible in many commercially available speech recognition systems to identify, with the desired good recognition results, commands in parallel to the list elements (mostly recorded as dynamic vocabulary). It is now proposed that the speech pattern supplied to the speech recognition system by the user is intermediate stored. Parallel thereto, the at least one element selected from the list by the speech recognizer is merged in a first recognition step with the system command to form a temporary recognizer vocabulary. After the production of this temporary recognizer vocabulary, subsequently the intermediate stored speech input is newly submitted to the recognizer, wherein this now forms the basis of this temporary recognizer vocabulary. Then, if thereby the speech pattern is recognized with higher probability as element of the system command than as the at least one selected element from the list, then it is accordingly interpreted by the speech recognition system as system command. On the other hand, when it is recognized with higher probability as list element, the speech pattern is interpreted as selection of this element by the user.

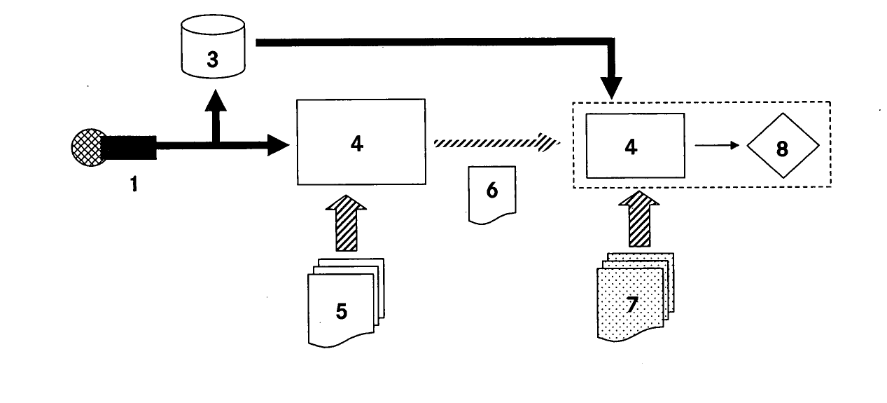

### BACKGROUND OF THE INVENTION

1. Field of the Invention

The invention concerns a process and a device for interaction with a speech recognition system for selection of elements from lists, in particular from text or voice enrollments.

2. Description of the Related Art

In many of the commercially available speech recognition systems it is presently not possible, due in particular to the large vocabulary to be recognized, to identify text elements (mostly stored as dynamic vocabulary) and system commands in parallel with the necessary good recognition reliability. Thus it is frequently not permissible to input, besides city names as target addresses, also system commands. This leads to the result, that the user of the system in this input mode finds himself in a dialog dead-end. If he fell into this position intentionally or unintentionally, for example by a erroneous recognition, then he cannot back out by speaking a system command. The input of the system command is automatically evaluated by the speech recognition system as the input of a city name. The dialog can thus be interrupted at this stage only by a manual input.

In order nevertheless to make possible a speech controlled termination of the dialog, it would be conceivable to define a distinctive system command which basically differs from, for example, city names. For this, one could select a very long command, such as for example “I would like to spell out the city names”. The problem therewith is however that a command of this type cannot be intuitively employed by the user. This is felt in particular when in other areas of the speech recognition system other intuitive commands are used for corrections.

From U.S. Pat. No. 5,231,670 A1 a speech recognition system is known, in which a speech signal is divided into speech commands and text elements. Herein a “system command” describes an action carried out by the system and the “text element” which usually follows within the speech signal represents the text to which this action is to be applied. To accomplish this it is proposed to separate the information contained in the command and text elements, and to supply these to, and process these independent of each other by, the recognizer. In this manner it becomes easier for the speech recognizer to associate the contained system commands or, as the case may be, text elements unambiguously into elements of the respective word lists. By which principle however the command and text elements are to be identified prior to extracting from the speech signal is however left open.

A process for identification of command and text elements in speech signals is described in European Patent EP 0785540 B1. For differentiating, it is proposed to check the individual elements of the speech signal for the presence of a structure typical for command elements or for text elements. In particular, it is proposed therein to observe the duration of interruptions and speech prior to or after the individual elements, wherefrom it can be concluded, that the presence of a command element can be presumed if prior to and/or after the element a significant interruption in speech is denoted.

### SUMMARY OF THE INVENTION

It is the task of the invention to provide a new type of process and a suitable device for a speech recognition system, by means of which distinction can be made between the input of a list element typical for this dialog step, in particular a text or voice enrollment, and a system command to be carried out in this dialog step.

The task is solved by a process and a device for interaction with a speech recognition system for selection of list elements with the characteristics as described herein. Advantageous embodiments and further developments of the invention can be seen from the dependent claims.

The system for interaction with a speech recognition system for selection of list entries is so designed, that a user can supply to the recognizer of the speech recognition system a speech pattern, in order to select at least one element from the list of vocabulary entries associated with the speech recognition system to be recognized. These lists could be either static or dynamic lists, which could also be partially predefined; these are in particular text or voice enrollments, which as a rule in speech recognition systems have a quite large scope. In inventive manner the speech pattern supplied to the system by the user is intermediate stored. Parallel thereto, the at least one list element selected by the speech recognizer from the list is, together with the system command, merged into a temporary recognizer vocabulary. After the production of this temporary recognizer vocabulary, subsequently the intermediate storage speech input is again supplied to the recognizer, wherein this distinguishes on the basis of this recognizer vocabulary. Then, if thereby the speech pattern is recognized with higher probability as element of the system command than as at least one selected list element, it is consequently interpreted appropriately by the speech recognition system as system command. On the other hand, in the case that the speech pattern is recognized with higher probability as list element, the speech pattern is interpreted as selection of this list element from the vocabulary of the list elements to be recognized by the user.

The invention is thus comprised therein, that in a first recognition process only the vocabulary (list) associated with the speech recognition system is activated with the list entries to be recognized, so for example a list of cities; herein this generally concerns a large dynamic vocabulary. The recognizer provides as recognition result a single entry, or possibly also multi-list entries, in response. Thereafter the recognizer, on the basis of the system commands to be recognized in parallel and the list element just supplied by the recognizer as recognition result, are once again called up with the speech signal recorded in the first recognition process. If in this second call-up the recognition result returns a system command, then the speech dialog system presumes, that the expression previously spoken by the user was a system command, so that it accordingly controls a further dialog sequence.

The improvement in recognition according to the invention is based upon the reduction of the vocabulary forming the basis of the recognizer. Particularly in the case of lists such as city names or street names many similar alternatives must be evaluated. As a result of the first recognition step the entries of the originally large list are reduced to usually a few list elements based on the results of the recognition. These do not burden very much the resources of the recognizer in the second recognition step so that an improved distinguishing between elements and system commands is made possible.

### BRIEF DESCRIPTION OF THE DRAWINGS

In the following the invention will be described in greater detail with the aide of a FIGURE, in which the speech recognition system is illustrated diagrammatically.

### DETAILED DESCRIPTION OF THE INVENTION

In general, the speech recognition system is provided with the speech signal via a microphone 1; of course, in the same way an electronic transmission of the speech signal via a suitable electronic or software technical realized input would also be conceivable. The speech signal supplied to the speech recognition system was, on the one hand, intermediate stored in a memory 3 and, the other hand, supplied to a recognizer 4. The recognizer proceeds on the basis of a vocabulary (list) 5 associated with it, with the list entries to be recognized. As recognition result 6 the recognizer 4 provides at least one element of the vocabulary 5 as list entry to be considered in the following. Of course, the recognizer can also be so designed, that it provides as the result 6 also multiple entries of the vocabulary 5. For this it is conceivable in an advantageous manner to so design the recognizer, that in order to make possible an improved evaluation quality a probability, in particular a confidence value, is associated with the individual selected or issued text enrollments. With the assistance of this probability then subsequently, from processes known in the state of the art, an improved validation and for the processing of the recognition result can occur.

The list elements 6 selected from the vocabulary by means of the recognizer 4, and in certain cases with taking into consideration of probability values, are then brought together collectively with the system command 7 to a temporary recognizer vocabulary. The new, temporary recognizer vocabulary provides the basis for the new recognition process, in which the speech signal intermediate stored in the memory 3 is supplied to the recognizer 4. On the basis of the recognition result 8 from the new recognition process it is then evaluated as to whether the speech signal originally supplied for speech recognition represents a system command 7 or a selection from the vocabulary 5 with the list elements to be recognized. Also, in this second run of the recognizer, it is of course conceivable that this provides multiple alternative recognition results 8, which on the basis of this assigned probabilities are subject to a qualitative validation and selection.

Now that the invention has been described, I claim:

1. A process for interaction with a speech recognition system for selection of elements from lists, comprising:
supplying the recognizer of the speech recognition system with a speech pattern from a user, in order to select at least one element from a vocabulary associated with the speech recognition system with list elements to be recognized, wherein
the speech pattern supplied to the system by the user is intermediate stored in a memory (3),
the at least one element (6) selected from the vocabulary of the speech recognition system by the recognizer is merged with the system commands (7) to form a temporary recognizer vocabulary,
subsequently the intermediate stored speech input is again supplied to the recognizer (4), whereupon this decides on the basis of the temporary recognizer vocabulary, and
when herein the speech pattern is recognized with higher probability as element of the system commands (7) than as at least one selected element (6) from the list (5), it in consequence is interpreted by the speech recognition system accordingly as system command and
in the case that the speech pattern is recognized with higher probability as element from the list, the speech pattern is interpreted as selection of this list element from the vocabulary of the list elements to be recognized (vocabulary) (5) by the user.

2. A process according to claim 1, wherein the recognizer (4) provides multiple alternative recognition results as selected list element (6).

3. A process according to claim 1, wherein the recognizer (4) provides probabilities for quality determination, in particular confidence values, with respect to a recognition result.

4. A process according to claim 1, wherein the speech pattern is supplied to the speech recognition system by speaking into a microphone (1).

5. A device for interaction with a speech recognition system for selection of text enrollments, which includes
a speech recognizer (4),
an input means (1) by means of which the user can supply speech patterns to the recognizer (4) of the speech recognition system, in order to select one element (6) from the list (vocabulary) (5) associated with the speech recognition system,
a memory (3) in which the speech pattern supplied by the user is intermediate stored,
a means, in order to merge the element (6) selected from the list (5) by the recognizer (4) of the speech recognition system together with the system commands (7) to form a temporary recognizer vocabulary,
wherein the recognizer (4) includes an interface, via which the speech input intermediate stored in the memory (3) can be supplied to the recognizer, so that the speech recognizer can process this speech input anew on the basis of the temporary recognizer vocabulary,
wherein the recognizer (4) is associated with a decision unit (8),
which then, beginning with the recognition result,
in the case that the speech pattern is recognized with higher probability as element of the system commands (7) than as at least one selected element from the list (5), the speech recognition system interprets this as system command, and
in the case that the speech pattern is recognized with higher probability as element of the list (5), the speech pattern is interpreted as selection of an element from the list (5).
